(19) United States
(12) Patent Application Publication
(10) Pub. No.: US 2023/0001763 A1
(43) Pub. Date: Jan. 5, 2023

(54) AIR CONDITIONING SYSTEM FOR ELECTRIC VEHICLE

(71) Applicants: HYUNDAI MOTOR COMPANY, SEOUL (KR); KIA CORPORATION, SEOUL (KR)

(72) Inventors: Gee Young Shin, Suwon-si (KR); Dae Hee Lee, Incheon (KR); Myung Hoe Kim, Seoul (KR); Dong Ho Kwon, Yongin-si (KR)

(21) Appl. No.: 17/696,227

(22) Filed: Mar. 16, 2022

(30) Foreign Application Priority Data
Jul. 2, 2021 (KR) 10-2021-0087069

(51) Int. Cl. B60H 1/00; B60L 58/26

(52) U.S. Cl. CPC B60H 1/00385; B60H 1/00885; B60H 1/00278; B60L 58/26; B60H 2001/00307

(57) ABSTRACT

In the present disclosure, heat sources for cooling and heating conditioning air are integrated as a coolant, both cooling performance and heating performance are ensured only by the coolant, and an entire package is reduced. That is, since a first air conditioning heat exchanger and a second air conditioning heat exchanger adjust a temperature of air, various types of air conditioning modes including cooling and heating modes may be implemented without using a separate temperature adjusting door. Accordingly, an overall size of an air conditioner is reduced. In addition, during cooling and heating processes, the first air conditioning heat exchanger and the second air conditioning heat exchanger are integrated and utilized. Therefore, the size of the heat exchanger may be reduced, the interior space may be ensured, and the air conditioning performance may be ensured without increasing a size of the heat exchanger.

### CROSS REFERENCE TO RELATED APPLICATIONS

The present application claims priority to Korean Patent Application No. 10-2021-0087069, filed Jul. 2, 2021, the entire contents of which is incorporated herein for all purposes by this reference.

### BACKGROUND

### Field

The present disclosure relates to an air conditioning system for an electric vehicle, which cools or heats air using a coolant, and has a reduced overall size.

### Description of the Related Art

An electric vehicle operates using a motor that outputs power by being supplied with electricity from a battery. Because the electric vehicle emits no carbon dioxide, generates low noise, and uses the motor with energy efficiency higher than energy efficiency of an engine, the electric vehicle is in the limelight as an environmentally friendly vehicle.

A key technology for implementing the electric vehicle is related to a battery module. Recently, studies have been actively conducted on a reduction in weight of a battery, a reduction in size of the battery, and a reduction in time taken to charge the battery. The battery module needs to be used in an optimal temperature environment to maintain an optimal performance and a long lifespan. However, the battery module is difficult to use in the optimal temperature environment because of a change in outside temperature and heat generated while the battery module operates.

In addition, because the electric vehicle emits no waste heat, which is generated during combustion in a separate internal combustion engine, the electric vehicle uses an electric heating device to heat the vehicle interior in the winter season. Further, because the electric vehicle needs to be warmed up, under a cold weather condition, to improve the performance of charging and discharging battery, the electric vehicle uses a separate electric heater that heats a coolant. That is, there is a technology that uses a cooling/heating system for adjusting a temperature of the battery module to maintain the optimal temperature environment for the battery module separately from a cooling/heating system for air conditioning of the vehicle interior.

In this case, the air conditioning system for air conditioning of the interior performs heat management by utilizing a refrigerant and a coolant. However, there is a problem in that the number of packages increases and the structure of the package is complicated because the number of components to be subjected to the heat management increases.

Therefore, there is a need for a method of unifying the heat source. However, if the heat source uses only the coolant, there is a problem in that cooling/heating performance deteriorates.

The above-mentioned matters described as the background art are provided merely to aid understanding of the background of the present disclosure, and should not be construed to admit that the matters correspond to the technologies already known to those skilled in the art.

### SUMMARY

The present disclosure has been made in an effort to solve the above-mentioned problems, and an object of the present disclosure is to provide an air conditioning system for an electric vehicle, which uses a coolant as a heat source for cooling and heating air, ensures cooling/heating performance only by using the coolant, and has a package with a reduced overall size.

An exemplary embodiment of the present disclosure provides an air conditioning system for an electric vehicle, the air conditioning system including a heater configured to perform a heating operation through heat exchange, a cooler configured to perform a cooling operation through heat exchange, and a coolant line configured to circulate a coolant, including a first air conditioning heat exchanger and a second air conditioning heat exchanger for cooling or heating air, and configured to allow the coolant to exchange heat in the cooler or the heater by a plurality of valves, wherein the coolant in the coolant line exchanges heat in the cooler or the heater as the respective valves are switched depending on whether to cool or heat the air, and the coolant exchanges heat with the air through the first air conditioning heat exchanger and the second air conditioning heat exchanger, such that conditioning air with an adjusted temperature is provided to an interior.

The air conditioning system may further include a refrigerant line configured to circulate a refrigerant and including a compressor, a heater, an expander, and a cooler, in which the heater is a condenser, and the cooler is an evaporator.

The coolant line may include a first coolant line including the first air conditioning heat exchanger, a first water pump, a first valve, and a second valve and connected to exchange heat with the cooler, and a second coolant line including the second air conditioning heat exchanger, a second water pump, a third valve, and a fourth valve and connected to exchange heat with the heater.

The first valve and the second valve may be respectively disposed at front and rear ends of the first air conditioning heat exchanger in the first coolant line, the third valve and the fourth valve may be respectively disposed at front and rear ends of the second air conditioning heat exchanger in the second coolant line, and the first coolant line and the second coolant line may be connected to each other by connecting the first valve and the third valve and connecting the second valve and the fourth valve.

To provide cooling air to the interior, the refrigerant may circulate through the compressor, the heater, the expander, and the cooler in the refrigerant line, and the coolant may circulate through the first air conditioning heat exchanger, the second air conditioning heat exchanger, and the cooler in the first coolant line and the second coolant line as the first valve, the second valve, the third valve, and the fourth valve are switched.

To provide heating air to the interior, the refrigerant may circulate through the compressor, the heater, the expander, and the cooler in the refrigerant line, and the coolant may circulate through the first air conditioning heat exchanger, the second air conditioning heat exchanger, and the heater in the first coolant line and the second coolant line as the first valve, the second valve, the third valve, and the fourth valve are switched.

The second coolant line may further include a coolant heater, and an operation of the coolant heater may be determined depending on a temperature of the coolant to provide the heating air to the interior.

To provide dehumidifying air to the interior, the refrigerant may circulate through the compressor, the heater, the expander, and the cooler in the refrigerant line, the coolant may circulate through the first air conditioning heat exchanger and the cooler in the first coolant line by the first valve and the second valve, and the coolant may circulate through the second air conditioning heat exchanger and the heater in the second coolant line by the third valve and the fourth valve.

The coolant line may further include a third coolant line which branches off from the second coolant line through a fifth valve, includes an electrical module, a radiator heat exchanger, and a third water pump, and is connected to exchange heat with the heater.

The coolant line may further include a fourth coolant line which branches off from the third coolant line through a sixth valve and a seventh valve and includes a battery module and a fourth water pump.

The refrigerant line may include a first refrigerant line which includes a compressor, a heater, a first expander, and a cooler; and a second refrigerant line which branches off from the first refrigerant line, shares the refrigerant, and includes a second expander and a chiller that allows the refrigerant to exchange heat with the coolant circulating in the fourth coolant line.

To provide cooling air to the interior, the first expander may expand the refrigerant, the second expander may be closed, and the coolant may circulate through the first air conditioning heat exchanger, the second air conditioning heat exchanger, and the cooler in the first coolant line and the second coolant line as the first valve, the second valve, the third valve, and the fourth valve are switched.

The coolant may circulate through the electrical module, the radiator heat exchanger, and the heater in the third coolant line by the fifth valve, the sixth valve, and the seventh valve.

To provide heating air to the interior, the first expander may be closed, the second expander may expand the refrigerant, and the coolant may circulate through the first air conditioning heat exchanger, the second air conditioning heat exchanger, and the heater in the first coolant line and the second coolant line as the first valve, the second valve, the third valve, and the fourth valve are switched.

The coolant may circulate through the electrical module, the battery module, and the chiller in the third coolant line and the fourth coolant line by the fifth valve, the sixth valve, and the seventh valve.

According to the air conditioning system for an electric vehicle having the aforementioned structure, the heat sources for cooling and heating the conditioning air are integrated as the coolant, both the cooling performance and the heating performance are ensured only by the coolant, and an entire package is reduced.

That is, since the first air conditioning heat exchanger and the second air conditioning heat exchanger adjust the temperature of the air, various types of air conditioning modes including cooling and heating modes may be implemented without using a separate temperature adjusting door. According to the present disclosure, an overall size of the air conditioner is reduced.

In addition, during the cooling and heating processes, the first air conditioning heat exchanger and the second air conditioning heat exchanger are integrated and utilized. Therefore, the size of the heat exchanger may be reduced, the interior space may be ensured, and the air conditioning performance may be ensured without increasing the size of the heat exchanger.

### BRIEF DESCRIPTION OF THE FIGURES

FIG. 1 is a view illustrating an air conditioning system for an electric vehicle according to an embodiment of the present disclosure.

FIG. 2 is a view illustrating a cooling mode of the air conditioning system for an electric vehicle illustrated in FIG. 1.

FIG. 3 is a view illustrating a heating mode of the air conditioning system for an electric vehicle illustrated in FIG. 1.

FIG. 4 is a view illustrating a dehumidifying mode of the air conditioning system for an electric vehicle illustrated in FIG. 1.

FIG. 5 is a view illustrating an air conditioning system for an electric vehicle according to another embodiment of the present disclosure.

FIG. 6 is a view illustrating a cooling mode of the air conditioning system for an electric vehicle illustrated in FIG. 5.

FIG. 7 is a view illustrating a heating mode of the air conditioning system for an electric vehicle illustrated in FIG. 5.

FIG. 8 is a view illustrating a dehumidifying mode of the air conditioning system for an electric vehicle illustrated in FIG. 5.

### DETAILED DESCRIPTION

Hereinafter, an air conditioning system for an electric vehicle according to an exemplary embodiment of the present disclosure will be described with reference to the accompanying drawings.

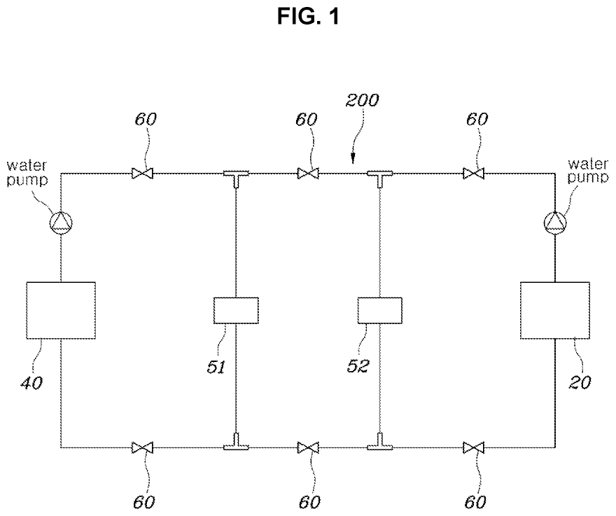

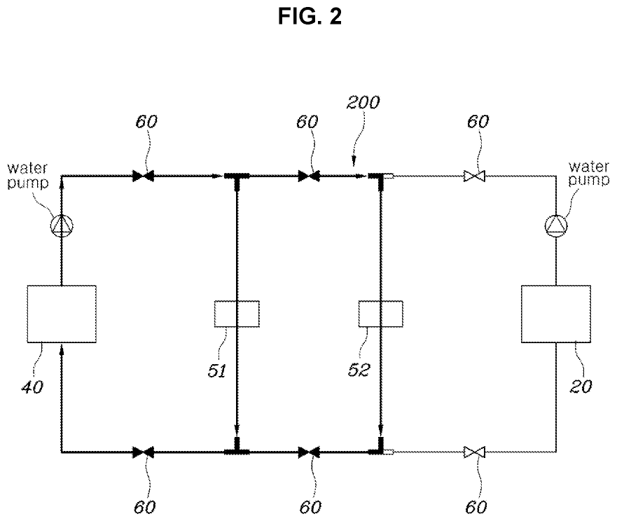

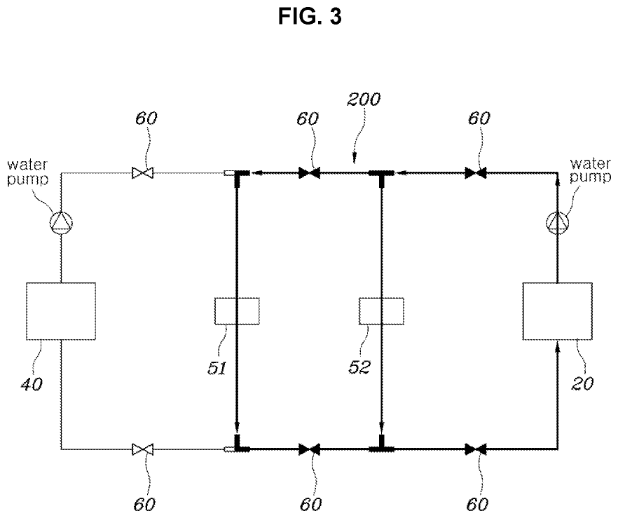

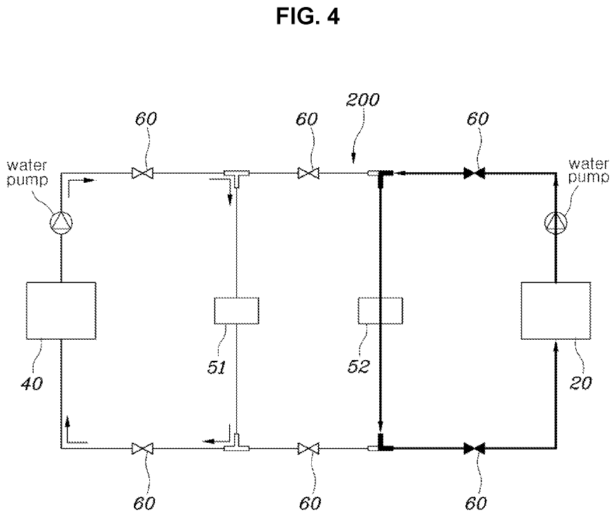

FIG. 1 is a view illustrating an air conditioning system for an electric vehicle according to an embodiment of the present disclosure, FIG. 2 is a view illustrating a cooling mode of the air conditioning system for an electric vehicle illustrated in FIG. 1, FIG. 3 is a view illustrating a heating mode of the air conditioning system for an electric vehicle illustrated in FIG. 1, and FIG. 4 is a view illustrating a dehumidifying mode of the air conditioning system for an electric vehicle illustrated in FIG. 1.

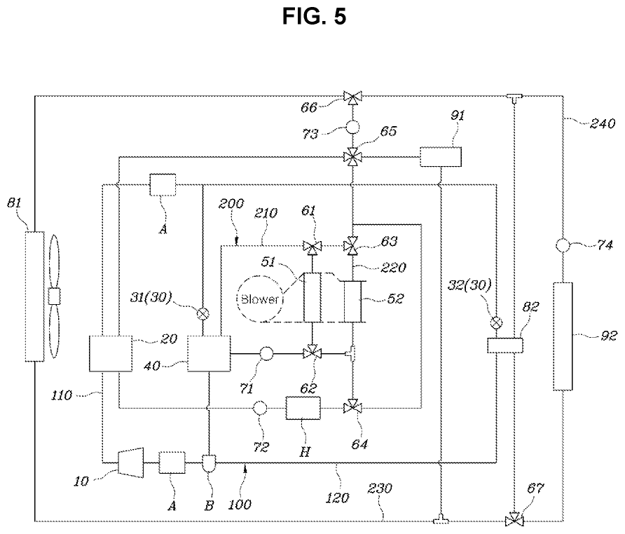

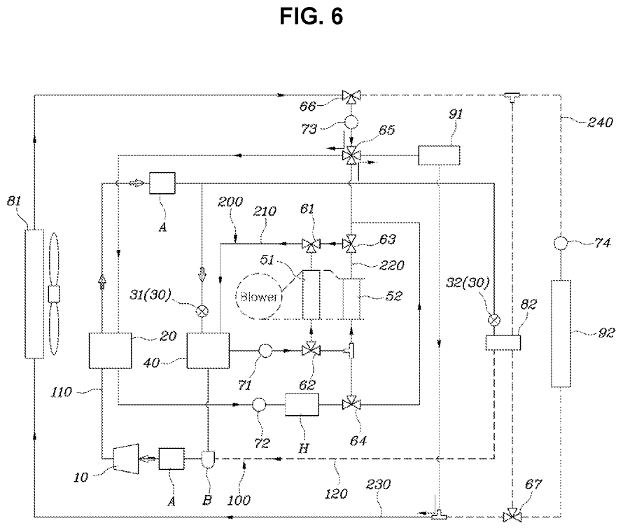

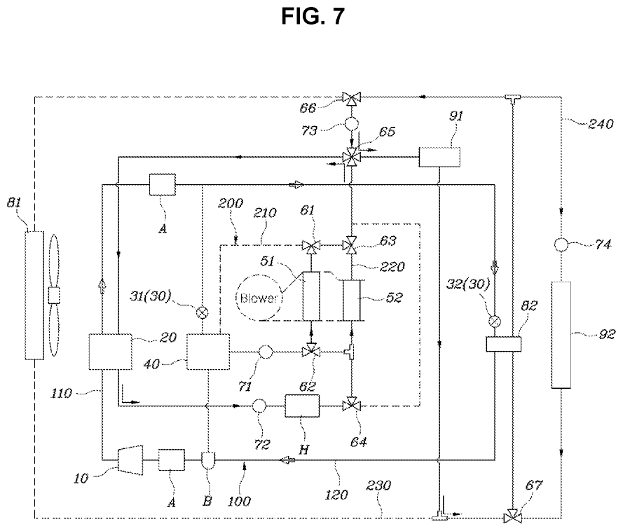

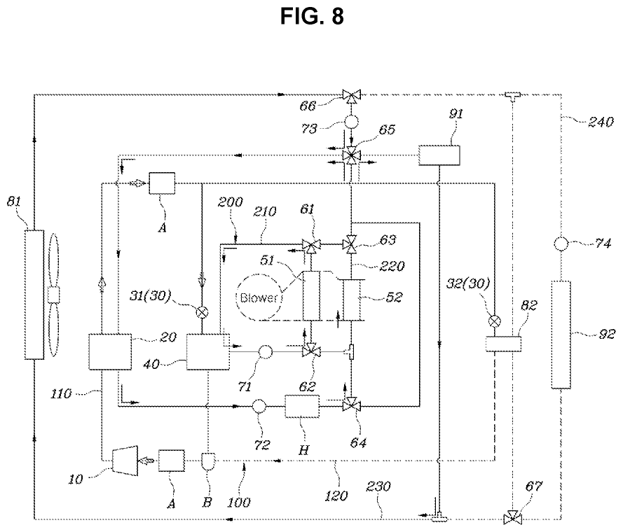

In addition, FIG. 5 is a view illustrating an air conditioning system for an electric vehicle according to another embodiment of the present disclosure, FIG. 6 is a view illustrating a cooling mode of the air conditioning system for an electric vehicle illustrated in FIG. 5, FIG. 7 is a view illustrating a heating mode of the air conditioning system for an electric vehicle illustrated in FIG. 5, and FIG. 8 is a view illustrating a dehumidifying mode of the air conditioning system for an electric vehicle illustrated in FIG. 5.

As illustrated in FIG. 1, an air conditioning system for an electric vehicle according to the present disclosure includes a heater 20 configured to perform a heating operation using heat exchange, a cooler 40 configured to perform a cooling operation using heat exchange, a first air conditioning heat exchanger 51 and a second air conditioning heat exchanger 52 configured to circulate a coolant and cool or heat air, and a coolant line 200 in which the coolant exchanges heat in the cooler 40 or the heater 20 by a plurality of valves 60.

That is, the coolant circulates in the coolant line 200, and the coolant line 200 connects the heater 20, the cooler 40, the first air conditioning heat exchanger 51, and the second air conditioning heat exchanger 52. In addition, one or more water pumps are provided in the coolant line 200, and the water pump operates to circulate the coolant. The plurality of valves 60 is provided in the coolant line 200, and the coolant selectively circulates through the heater 20, the cooler 40, the first air conditioning heat exchanger 51, and the second air conditioning heat exchanger 52 depending on whether the respective valves 60 are opened or closed.

In this case, the heater 20 heats the coolant. The heater 20 may be configured to raise a temperature of the coolant circulating in the coolant line 200 by exchanging heat with a medium such as electrical energy, a refrigerant, or outside air.

The cooler 40 cools the coolant. The cooler 40 may be configured to lower a temperature of the coolant using another medium, except for the coolant, such as electrical energy, a refrigerant, or outside air that circulates in the coolant line 200.

In the present disclosure, the heater 20 may be configured as a condenser, and the cooler 40 may be configured as an evaporator. The temperature of the coolant may be raised or lowered by heat exchange between the refrigerant and the coolant circulating in the heater 20 or the cooler 40. This configuration will be described below in detail.

In the present disclosure, the respective valves 60 are switched depending on whether to cool or heat the air, such that the coolant in the coolant line 200 exchanges heat in the cooler 40 or the heater 20, and the coolant exchanges heat with the air through the first air conditioning heat exchanger 51 and the second air conditioning heat exchanger 52, thereby providing the interior with the conditioning air at an adjusted temperature.

In this case, the valves 60 are controlled by a controller. The controller allows the coolant to circulate in the cooler 40 or the heater 20 by controlling the respective valves 60 based on a temperature required by a user or an automatically set temperature.

Meanwhile, the outside air or the inside air, which flows by an operation of a blower, passes through the first air conditioning heat exchanger 51 and the second air conditioning heat exchanger 52 and then circulates in the interior. That is, the outside air or the inside air exchanges heat with the coolant in the conditioning heat exchanger 51 and the second air conditioning heat exchanger 52 while passing through the first air conditioning heat exchanger 51 and the second air conditioning heat exchanger 52. Therefore, the temperature may be adjusted, and the conditioning air with the adjusted temperature may circulate in the interior, thereby providing the air with a temperature required in the interior.

In the present disclosure, since the first air conditioning heat exchanger 51 and the second air conditioning heat exchanger 52 adjust the temperature of the air, various types of air conditioning modes including cooling and heating modes may be implemented without using a separate temperature adjusting door. According to the present disclosure, an overall size of the air conditioner is reduced.

In addition, during the cooling and heating processes, the first air conditioning heat exchanger 51 and the second air conditioning heat exchanger 52 are integrated and utilized. Therefore, the size of the heat exchanger may be reduced, the interior space may be ensured, and the air conditioning performance may be ensured without increasing the size of the heat exchanger.

According to the present disclosure, the cooling mode, the heating mode, and the dehumidifying mode may be implemented as described below.

As illustrated in FIG. 2, in the cooling mode in which cooling air needs to be provided to the interior, the respective valves 60 are opened or closed to allow the coolant to circulate through the cooler 40, the first air conditioning heat exchanger 51, and the second air conditioning heat exchanger 52.

As the cooled coolant circulates through the first air conditioning heat exchanger 51 and the second air conditioning heat exchanger 52, the air passing through the first air conditioning heat exchanger 51 and the second air conditioning heat exchanger 52 exchanges heat with the coolant in the first air conditioning heat exchanger 51 and the second air conditioning heat exchanger 52 to form the cooling air.

Meanwhile, as illustrated in FIG. 3, in the heating mode in which heating air needs to be provided to the interior, the respective valves 60 are opened or closed to allow the coolant to circulate through the heater 20, the first air conditioning heat exchanger 51, and the second air conditioning heat exchanger 52.

As the heated coolant circulates through the first air conditioning heat exchanger 51 and the second air conditioning heat exchanger 52, the air passing through the first air conditioning heat exchanger 51 and the second air conditioning heat exchanger 52 exchanges heat with the coolant in the first air conditioning heat exchanger 51 and the second air conditioning heat exchanger 52 to form the heating air.

As described above, in the cooling mode or the heating mode, the air passes through the first air conditioning heat exchanger 51 and the second air conditioning heat exchanger 52, and the heat exchange area is ensured, such that the cooling/heating performance is ensured. In addition, at the time of adjusting the temperature of the air, the valves 60 may be switched to allow the coolant to selectively circulate through the first air conditioning heat exchanger 51 and the second air conditioning heat exchanger 52 to adjust the temperature of the air.

Meanwhile, as illustrated in FIG. 4, in a dehumidifying mode in which dehumidifying air needs to be provided to the interior, the respective valves 60 are opened or closed, such that the coolant is divided into a coolant, which circulates through the cooler 40 and the first air conditioning heat exchanger 51, and a coolant which circulates through the heater 20 and the second air conditioning heat exchanger 52.

Therefore, the coolant cooled by the cooler 40 circulates through the first air conditioning heat exchanger 51 to cool the flowing air, and the coolant heated by the heater 20 circulates through the second air conditioning heat exchanger 52 to heat the flowing air, thereby implementing a dehumidifying effect. Therefore, the dehumidified dehumidifying air may be provided to the interior.

Meanwhile, as illustrated in FIG. 5, the air conditioning system for an electric vehicle according to the embodiment of the present disclosure further includes a refrigerant line 100 configured to circulate the refrigerant and including a compressor 10, a heater 20, an expander 30, and a cooler 40. In this case, the heater 20 may be a condenser, and the cooler 40 may be an evaporator.

That is, the refrigerant line 100 allows the refrigerant and the coolant in the coolant line 200 to exchange heat with each other to adjust a temperature of the coolant to a required temperature. The heater 20 is the condenser that allows the high-temperature refrigerant to exchange heat with the coolant, and the cooler 40 is the evaporator that allows the low-temperature refrigerant to exchange heat with the coolant.

Meanwhile, the coolant line 200 includes a first coolant line 210 including the first air conditioning heat exchanger 51, a first water pump 71, a first valve 61, and a second valve 62 and connected to exchange heat with the cooler 40, and a second coolant line 220 including the second air conditioning heat exchanger, a second water pump 72, a third valve 63, and a fourth valve 64 and connected to exchange heat with the heater 20.

As described above, the coolant line 200 includes the first coolant line 210 and the second coolant line 220, and the first coolant line 210 and the second coolant line 220 share the coolant. Therefore, in the first coolant line 210, the coolant may be circulated by the operation of the first water pump 71, and the coolant may selectively circulate through the cooler 40 depending on whether the first valve 61, the second valve 62, the third valve 63, and the fourth valve 64 are opened or closed. In addition, in the second coolant line 220, the coolant is circulated by the operation of the second water pump 72, and the coolant may selectively circulate through the heater 20 depending on whether the first valve 61, the second valve 62, the third valve 63, and the fourth valve 64 are opened or closed.

The first valve 61 and the second valve 62 are respectively disposed at front and rear ends of the first air conditioning heat exchanger 51 in the first coolant line 210, and the third valve 63 and the fourth valve 64 are respectively disposed at front and rear ends of the second air conditioning heat exchanger in the second coolant line 220, such that the coolant may selectively circulate through the cooler 40 or the heater 20 and then circulate through the first air conditioning heat exchanger 51 and the second air conditioning heat exchanger 52.

In addition, the first valve 61 and the third valve 63 are connected to each other, and the second valve 62 and the fourth valve 64 are connected to each other, such that the first coolant line 210 and the second coolant line 220 are connected to each other. Therefore, the circulation direction of the coolant may be determined depending on whether the first valve 61, the second valve 62, the third valve 63, and the fourth valve 64 are opened or closed.

As described above, the circulation direction of the coolant in the first coolant line 210 and the second coolant line 220 is determined depending on whether the first valve 61, the second valve 62, the third valve 63, and the fourth valve 64 are opened or closed, such that the coolant cooled by passing through the cooler 40 or the coolant heated by passing through the heater 20 circulates through the first air conditioning heat exchanger 51 or the second air conditioning heat exchanger 52. Therefore, the coolant and the air may exchange heat with each other in the first air conditioning heat exchanger 51 and the second air conditioning heat exchanger 52, thereby providing the cooling/heating conditioning air to the interior.

Therefore, according to the present disclosure, in order to provide the cooling air to the interior, the refrigerant circulates through the compressor 10, the heater 20, the expander 30, and the cooler 40 in the refrigerant line 100, and the coolant circulates through the first air conditioning heat exchanger 51, the second air conditioning heat exchanger, and the cooler 40 in the first coolant line 210 and the second coolant line 220 as the first valve 61, the second valve 62, the third valve 63, and the fourth valve 64 are switched.

That is, as illustrated in FIG. 6, in the refrigerant line 100, the refrigerant circulates through the compressor 10, the heater 20, the expander 30, and the cooler 40, thereby cooling a peripheral medium through the cooler 40.

In addition, in the first coolant line 210, the coolant circulates through the first air conditioning heat exchanger 51 and the cooler 40 by the first valve 61 and the second valve 62. In the second coolant line 220, the coolant circulates through the second air conditioning heat exchanger 52 by the third valve 63 and the fourth valve 64. In addition, the first valve 61, the second valve 62, the third valve 63, and the fourth valve 64 operate to allow the first coolant line 210 and the second coolant line 220 to share the coolant.

Therefore, the temperature of the coolant is lowered as the coolant passes through the cooler 40 in the first coolant line 210 and the second coolant line 220, and the coolant with the lowered temperature circulates through the first air conditioning heat exchanger 51 and the second air conditioning heat exchanger 52. Therefore, the air passing through the first air conditioning heat exchanger 51 and the second air conditioning heat exchanger 52 is cooled by exchanging heat with the coolant in the first air conditioning heat exchanger 51 and the second air conditioning heat exchanger 52 and provided to the interior as the cooling air.

Meanwhile, according to the present disclosure, in order to provide the heating air to the interior, the refrigerant circulates through the compressor 10, the heater 20, the expander 30, and the cooler 40 in the refrigerant line 100, and the coolant circulates through the first air conditioning heat exchanger 51, the second air conditioning heat exchanger 52, and the heater 20 in the first coolant line 210 and the second coolant line 220 as the first valve 61, the second valve 62, the third valve 63, and the fourth valve 64 are switched.

As illustrated in FIG. 7, in the refrigerant line 100, the refrigerant circulates through the compressor 10, the heater 20, the expander 30, and the cooler 40, thereby heating the peripheral medium through the heater 20.

In addition, in the first coolant line 210, the coolant does not circulate through the cooler 40 but circulates only through the first air conditioning heat exchanger 51 by the first valve 61 and the second valve 62. In the second coolant line 220, the coolant circulates through the heater 20 and the second air conditioning heat exchanger 52 by the third valve 63 and the fourth valve 64. In addition, the first valve 61, the second valve 62, the third valve 63, and the fourth valve 64 operate to allow the first coolant line 210 and the second coolant line 220 to share the coolant.

In this case, the second coolant line 220 may further include a coolant heater H. The coolant heater H serves to heat the coolant. When the temperature of the coolant is not raised to a target temperature, the coolant heater H operates to raise the temperature of the coolant to the target temperature, thereby supplementing the insufficient heat source.

Therefore, the temperature of the coolant is raised as the coolant passes through the heater 20 and the coolant heater H in the first coolant line 210 and the second coolant line 220, and the coolant with the raised temperature circulates through the first air conditioning heat exchanger 51 and the second air conditioning heat exchanger 52. Therefore, the air passing through the first air conditioning heat exchanger 51 and the second air conditioning heat exchanger 52 is heated by exchanging heat with the coolant in the first air conditioning heat exchanger 51 and the second air conditioning heat exchanger 52 and provided to the interior as the heating air.

Meanwhile, in order to provide the dehumidifying air to the interior, the refrigerant may circulate through the compressor 10, the heater 20, the expander 30, and the cooler 40 in the refrigerant line 100, the coolant may circulate through the first air conditioning heat exchanger 51 and the cooler 40 in the first coolant line 210 by the first valve 61 and the second valve 62, and the coolant may circulate through the second air conditioning heat exchanger and the heater 20 in the second coolant line 220 by the third valve 63 and the fourth valve 64.

As illustrated in FIG. 8, the refrigerant circulates through the compressor 10, the heater 20, the expander 30, and the cooler 40 in the refrigerant line 100, thereby cooling the peripheral medium through the cooler 40 and heating the peripheral medium through the heater 20.

In addition, in the first coolant line 210, the coolant circulates through the first air conditioning heat exchanger 51 and the cooler 40 by the first valve 61 and the second valve 62. In the second coolant line 220, the coolant circulates through the heater 20 and the second air conditioning heat exchanger 52 by the third valve 63 and the fourth valve 64. In addition, the first valve 61, the second valve 62, the third valve 63, and the fourth valve 64 operate to divide the coolant in the first coolant line 210 and the second coolant line 220.

Therefore, the coolant cooled by the cooler 40 circulates through the first air conditioning heat exchanger 51, and the flowing air is cooled by exchanging heat with the coolant in the first air conditioning heat exchanger 51. In addition, the coolant heated by the heater 20 circulates through the second air conditioning heat exchanger 52, and the flowing air is heated by exchanging heat with the coolant in the second air conditioning heat exchanger 52, thereby implementing the dehumidifying effect. Therefore, the dehumidified dehumidifying air may be provided to the interior.

Meanwhile, as illustrated in FIG. 5, in the present disclosure, the coolant line 200 may further include a third coolant line 230 which branches off from the second coolant line 220 through a fifth valve 65, includes an electrical module 91, a radiator heat exchanger 81, and a third water pump 73, and is connected to exchange heat with the heater 20.

In addition, the coolant line 200 may further include a fourth coolant line 240 which branches off from the third coolant line 230 through a sixth valve 66 and a seventh valve 67 and includes a battery module 92 and a fourth water pump 74.

In addition, the refrigerant line 100 may include a first refrigerant line 110 including the compressor 10, the heater 20, the first expander 31, and the cooler 40, and a second refrigerant line 120 which branches off from the first refrigerant line 110, shares the refrigerant, and includes the chiller 82 and the second expander 32 so that the refrigerant exchanges heat with the coolant circulating through the fourth coolant line 240. In this case, in the first refrigerant line 110, a separate heat exchanger A may be further provided to ensure the performance implemented by the circulation of the refrigerant, and an accumulator B may be further provided.

The third coolant line 230, the fourth coolant line 240, the first refrigerant line 110, and the second refrigerant line 120 are provided to cool the electrical module 91 and the battery module 92 and perform the heat pumping through the heater 20 and the chiller 82.

In this case, the third coolant line 230 may be connected to the second coolant line 220 through the third valve 63. Therefore, the coolant passes through the electrical module 91 in the third coolant line 230 by the fifth valve 65, and the electrical module 91 is cooled. The coolant, which has cooled the electrical module 91, may be cooled by the radiator heat exchanger 81 and then exchange heat in the heater 20. Therefore, the refrigerant exchanges heat with the coolant in the heater 20, such that the heat pumping may be performed as the temperature is lowered.

In addition, the battery module 92 may be cooled when the coolant passes through the battery module 92 in the fourth coolant line 240 by the sixth valve 66 and the seventh valve 67. Further, the chiller 82 may perform the heat pumping by inducing the heat exchange between the refrigerant and the coolant.

This configuration will be specifically described. In the cooling mode in which the cooling air needs to be provided to the interior, the first expander 31 expands the refrigerant, the second expander 32 is closed, and the coolant circulates through the first air conditioning heat exchanger 51, the second air conditioning heat exchanger 52, and the cooler 40 in the first coolant line 210 and the second coolant line 220 as the first valve 61, the second valve 62, the third valve 63, and the fourth valve 64 are switched.

In addition, the coolant may circulate through the electrical module 91, the radiator heat exchanger 81, and the heater 20 in the third coolant line 230 by the fifth valve 65, the sixth valve 66, and the seventh valve 67.

That is, as illustrated in FIG. 6, the refrigerant circulates through the compressor 10, the heater 20, the first expander 31, and the cooler 40 in the refrigerant line 100.

In addition, in the first coolant line 210, the coolant circulates through the first air conditioning heat exchanger 51 and the cooler 40 by the first valve 61 and the second valve 62. In the second coolant line 220, the coolant circulates through the second air conditioning heat exchanger 52 by the third valve 63 and the fourth valve 64. In addition, the first valve 61, the second valve 62, the third valve 63, and the fourth valve 64 operate to allow the first coolant line 210 and the second coolant line 220 to share the coolant.

Therefore, the temperature of the coolant is lowered as the coolant passes through the cooler 40 in the first coolant line 210 and the second coolant line 220, and the coolant with the lowered temperature circulates through the first air conditioning heat exchanger 51 and the second air conditioning heat exchanger 52. Therefore, the air passing through the first air conditioning heat exchanger 51 and the second air conditioning heat exchanger 52 is cooled by exchanging heat with the coolant in the first air conditioning heat exchanger 51 and the second air conditioning heat exchanger 52 and provided to the interior as the cooling air.

Further, the coolant cooled by the radiator heat exchanger 81 in the third coolant line 230 circulates through the heater 20 and exchanges heat with the refrigerant, such that the performance of the cooler 40 implemented by the heat pumping may be ensured.

Meanwhile, in the heating mode in which the heating air needs to be provided to the interior, the first expander 31 is closed, the second expander 32 expands the refrigerant, and the coolant circulates through the first air conditioning heat exchanger 51, the second air conditioning heat exchanger 52, and the heater 20 in the first coolant line 210 and the second coolant line 220 as the first valve 61, the second valve 62, the third valve 63, and the fourth valve 64 are switched.

In addition, the coolant circulates through the electrical module 91, the battery module 92, and the chiller 82 in the third coolant line 230 and the fourth coolant line 240 by the fifth valve 65, the sixth valve 66, and the seventh valve 67.

That is, as illustrated in FIG. 7, the refrigerant circulates through the compressor 10, the heater 20, the second expander 32, and the cooler 40 in the refrigerant line 100.

In addition, in the first coolant line 210, the coolant does not circulate through the cooler 40 but circulates only through the first air conditioning heat exchanger 51 by the first valve 61 and the second valve 62. In the second coolant line 220, the coolant circulates through the heater 20 and the second air conditioning heat exchanger 52 by the third valve 63 and the fourth valve 64. In addition, the first valve 61, the second valve 62, the third valve 63, and the fourth valve 64 operate to allow the first coolant line 210 and the second coolant line 220 to share the coolant.

Therefore, the temperature of the coolant is raised as the coolant passes through the heater 20 in the first coolant line 210 and the second coolant line 220, and the coolant with the raised temperature circulates through the first air conditioning heat exchanger 51 and the second air conditioning heat exchanger 52. Therefore, the air passing through the first air conditioning heat exchanger 51 and the second air conditioning heat exchanger 52 is heated by exchanging heat with the coolant in the first air conditioning heat exchanger 51 and the second air conditioning heat exchanger 52 and provided to the interior as the heating air.

Further, the coolant circulating in the fourth coolant line 240 cools the electrical module 91 and the battery module 92. Therefore, the coolant, which has a raised temperature as the coolant cools the electrical module 91 and the battery module 92, is cooled again by exchanging heat with the refrigerant through the chiller 82, and thus the coolant may cool the electrical module 91 and the battery module 92. In addition, the chiller 82 may serve as an evaporator in the refrigerant line 100, and the refrigerant and the coolant exchange heat in the chiller 82. In this case, in the case of the battery module 92, the coolant may selectively circulate by the sixth valve 66 and the seventh valve 67 in accordance with a required temperature condition.

According to the air conditioning system for an electric vehicle having the aforementioned structure, the heat sources for cooling and heating the conditioning air are integrated as the coolant, both the cooling performance and the heating performance are ensured only by the coolant, and an entire package is reduced.

That is, since the first air conditioning heat exchanger and the second air conditioning heat exchanger adjust the temperature of the air, various types of air conditioning modes including cooling and heating modes may be implemented without using a separate temperature adjusting door. According to the present disclosure, an overall size of the air conditioner is reduced.

In addition, during the cooling and heating processes, the first air conditioning heat exchanger and the second air conditioning heat exchanger are integrated and utilized. Therefore, the size of the heat exchanger may be reduced, the interior space may be ensured, and the air conditioning performance may be ensured without increasing the size of the heat exchanger.

While the specific embodiments of the present disclosure have been illustrated and described, it will be obvious to those skilled in the art that the present disclosure may be variously modified and changed without departing from the technical spirit of the present disclosure defined in the appended claims.

1. An air conditioning system for an electric vehicle, the air conditioning system comprising:
a heater configured to perform a heating operation through heat exchange;
a cooler configured to perform a cooling operation through heat exchange; and
a coolant line configured to circulate a coolant, the coolant line comprising a first air conditioning heat exchanger and a second air conditioning heat exchanger for cooling or heating air, and being configured to allow the coolant to exchange heat in the cooler or the heater by a plurality of valves;
wherein the coolant in the coolant line exchanges heat in the cooler or the heater as the plurality of valves are switched depending on whether to cool or heat the air, and the coolant exchanges heat with the air through the first air conditioning heat exchanger and the second air conditioning heat exchanger, conditioning air with an adjusted temperature is provided to an interior.

2. The air conditioning system of claim 1, further comprising:
a refrigerant line configured to circulate a refrigerant, and comprising a compressor, a heater, an expander, and a cooler;
wherein the heater is a condenser, and the cooler is an evaporator.

3. The air conditioning system of claim 2, wherein the coolant line further comprises:
a first coolant line comprising the first air conditioning heat exchanger, a first water pump, a first valve, and a second valve and connected to exchange heat with the cooler; and
a second coolant line comprising the second air conditioning heat exchanger, a second water pump, a third valve, and a fourth valve and connected to exchange heat with the heater.

4. The air conditioning system of claim 3, wherein the first valve is positioned at a front end of the first air conditioning heat exchanger, the second valve is positioned at a rear end of the first air conditioning heat exchanger in the first coolant line, the third valve is positioned at a front end of the second air conditioning heat exchanger, the fourth valve is positioned at a rear ends of the second air conditioning heat exchanger in the second coolant line, and the first coolant line and the second coolant line are connected to each other by connecting the first valve to the third valve and connecting the second valve to the fourth valve.

5. The air conditioning system of claim 3, wherein to provide cooling air to the interior, the refrigerant circulates through the compressor, the heater, the expander, and the cooler in the refrigerant line, and the coolant circulates through the first air conditioning heat exchanger, the second air conditioning heat exchanger, and the cooler in the first coolant line and the second coolant line as the first valve, the second valve, the third valve, and the fourth valve are switched.

6. The air conditioning system of claim 3, wherein to provide heating air to the interior, the refrigerant circulates through the compressor, the heater, the expander, and the cooler in the refrigerant line, and the coolant circulates through the first air conditioning heat exchanger, the second air conditioning heat exchanger, and the heater in the first coolant line and the second coolant line as the first valve, the second valve, the third valve, and the fourth valve are switched.

7. The air conditioning system of claim 6, wherein the second coolant line further comprises a coolant heater, wherein an operation of the coolant heater is determined depending on a temperature of the coolant to provide the heating air to the interior.

8. The air conditioning system of claim 3, wherein to provide dehumidifying air to the interior, the refrigerant circulates through the compressor, the heater, the expander, and the cooler in the refrigerant line, the coolant circulates through the first air conditioning heat exchanger and the cooler in the first coolant line by the first valve and the second valve, and the coolant circulates through the second air conditioning heat exchanger and the heater in the second coolant line by the third valve and the fourth valve.

9. The air conditioning system of claim 3, wherein the coolant line further comprises a third coolant line which branches off from the second coolant line through a fifth valve, and wherein the third coolant line comprises an electrical module, a radiator heat exchanger, and a third water pump, and is connected to exchange heat with the heater.

10. The air conditioning system of claim 9, wherein the coolant line further comprises a fourth coolant line which branches off from the third coolant line through a sixth valve and a seventh valve, and wherein the fourth coolant line comprises a battery module and a fourth water pump.

11. The air conditioning system of claim 10, wherein the refrigerant line comprises:
a first refrigerant line comprising a compressor, a heater, a first expander, and a cooler; and
a second refrigerant line which branches off from the first refrigerant line, shares the refrigerant, and comprises a second expander and a chiller that allows the refrigerant to exchange heat with the coolant circulating in the fourth coolant line.

12. The air conditioning system of claim 11, wherein to provide cooling air to the interior, the first expander expands the refrigerant, the second expander is closed, and the coolant circulates through the first air conditioning heat exchanger, the second air conditioning heat exchanger, and the cooler in the first coolant line and the second coolant line as the first valve, the second valve, the third valve, and the fourth valve are switched.

13. The air conditioning system of claim 12, wherein the coolant circulates through the electrical module, the radiator heat exchanger, and the heater in the third coolant line by the fifth valve, the sixth valve, and the seventh valve.

14. The air conditioning system of claim 11, wherein to provide heating air to the interior, the first expander is closed, the second expander expands the refrigerant, and the coolant circulates through the first air conditioning heat exchanger, the second air conditioning heat exchanger, and the heater in the first coolant line and the second coolant line as the first valve, the second valve, the third valve, and the fourth valve are switched.

15. The air conditioning system of claim 14, wherein the coolant circulates through the electrical module, the battery module, and the chiller in the third coolant line and the fourth coolant line by the fifth valve, the sixth valve, and the seventh valve.
